(19) United States
(12) Patent Application Publication
(10) Pub. No.: US 2015/0321861 A1
(43) Pub. Date: Nov. 12, 2015

(54) RAMP DEPLOYMENT SYSTEM UTILIZING A RATCHET STRAP MECHANISM

(71) Applicants: Steve Smith, Alton, IL (US); Vern Van Hoy, Alton, IL (US)

(72) Inventors: Steve Smith, Alton, IL (US); Vern Van Hoy, Alton, IL (US)

(73) Assignee: Nature's Second Chance Hauling, LLC, Alton, IL (US)

(21) Appl. No.: 14/274,101

(22) Filed: May 9, 2014

(51) Int. Cl. B65G 69/00; B65G 69/30

(52) U.S. Cl. CPC B65G 69/00; B65G 69/30

(57) ABSTRACT

A ramp deployment system for securing a mobile ramp arrangement including a first ramp and a second ramp to the entrance of a trailer using a ratchet strap mechanism is disclosed. The ratchet strap mechanism includes a first ratchet strap that is secured between the first ramp and the trailer and a second ratchet strap that is secured between the second ramp and the trailer when the ratchet strap mechanism is actuated such that the mobile ramp arrangement is sufficiently secured to the trailer to support the weight of a utility vehicle that is accessing the trailer.

### FIELD

The present disclosure relates to ramp deployment system, and in particular to a ramp deployment system having a ratchet strap mechanism that permits secure attachment of a mobile ramp from a trailer or other type of container vehicle.

### BACKGROUND

Light-weight, mobile ramps are used to allow access to the inside of trailers, trucks or other types of container vehicles. For example, such mobile ramps can be used to permit utility vehicles, such as forklifts, to access the trailer and haul loaded pallets or bound material into or from the inside of the trailer. There are many different arrangements of mobile ramps that can be stored and then deployed from a trailer. A single pair ramp arrangement includes a pair of mobile ramps that support the respective left-side and right-side tires of the utility vehicle to establish a support pathway between the trailer and a lower surface for the utility vehicle to access the trailer. Typically, the mobile ramps are stored inside the trailer, and therefore must be manually deployed from the trailer by one or more individuals. The mobile ramps are temporary and therefore have the potential to move while in use. As such, the mobile ramps must be secure and not move while a utility vehicle is moving across the mobile ramps. Because heavy utility vehicles and loaded pallets must travel up and down the mobile ramps, there is a need for a mechanism to securely stabilize and attach the mobile ramps to the trailer.

### BRIEF DESCRIPTION OF THE DRAWINGS

FIGS. 1A and 1B are perspective views of a ratchet strap mechanism with two hook ends and a ratchet arrangement for use in a ramp deployment system;

FIG. 2 is a side perspective view of the ramp deployment system with the ratchet strap mechanism connected to the trailer and a mobile ramp arrangement around a safety bar of a trailer;

FIG. 3 is a perspective view of a first end of the ratchet strap mechanism attached to the underside of the trailer;

FIG. 4 is perspective view of the ratchet strap mechanism having a second end connected to the mobile ramp of the mobile ramp arrangement;

FIG. 5 is a front view the ramp deployment system with first and second mobile ramps connected to the trailer by the ratchet strap mechanisms;

FIG. 6 illustrates the use of the ramp deployment system to support a utility vehicle on the mobile ramps connected to the trailer; and

FIG. 7 is a flow chart illustrating a method of securing the ramp deployment system using the ratchet strap mechanism.

Corresponding reference characters indicate corresponding elements among the various views of the drawings. The headings used in the figures should not be interpreted to limit the scope of the claims.

### DETAILED DESCRIPTION

As described herein, a ramp deployment system and method of using the ramp system deployment having a ratchet strap mechanism configured and arranged for securing a mobile ramp arrangement to a truck, trailer, or other type of container vehicle using a ratchet strap system. Once the ramp arrangement is secured to the trailer with the ratchet strap mechanism, utility vehicles, such as forklifts, can ride on the ramp arrangement to access the trailer and haul loaded pallets or bound material into or from the inside of the trailer.

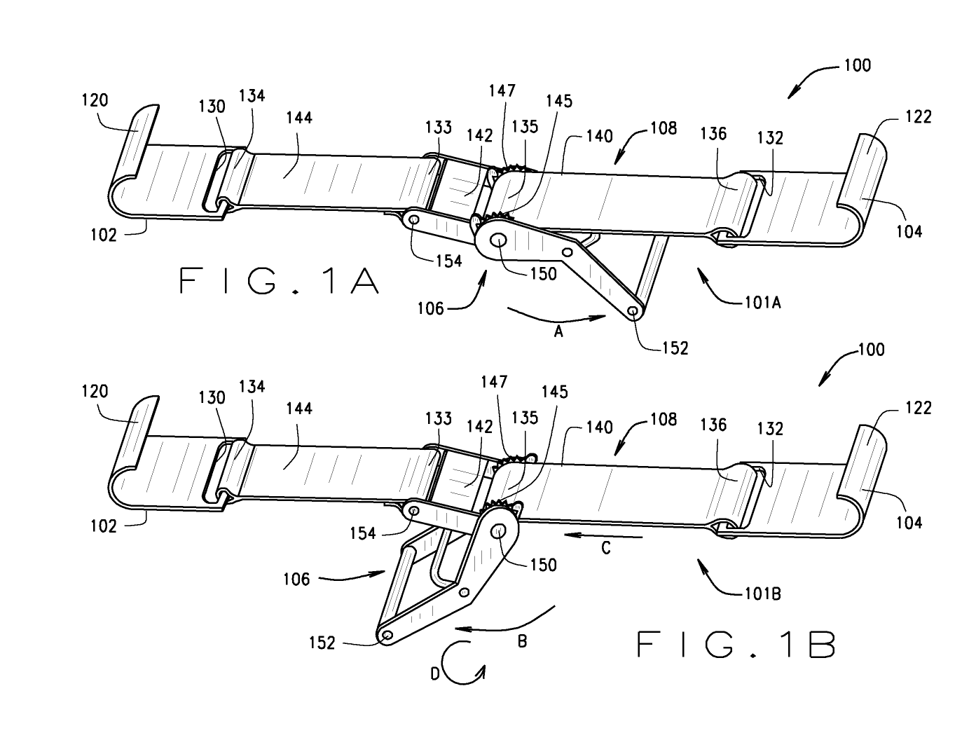

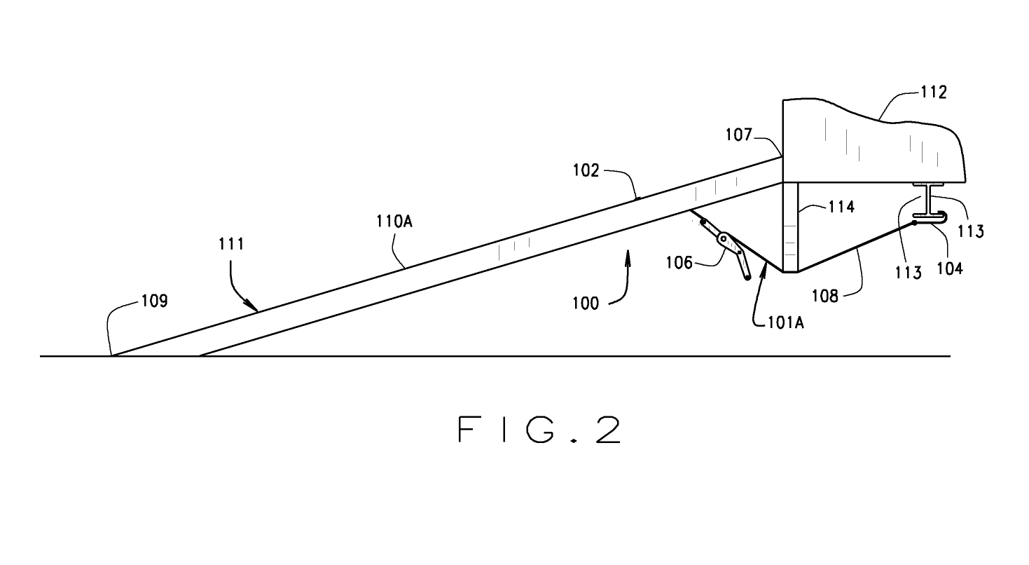

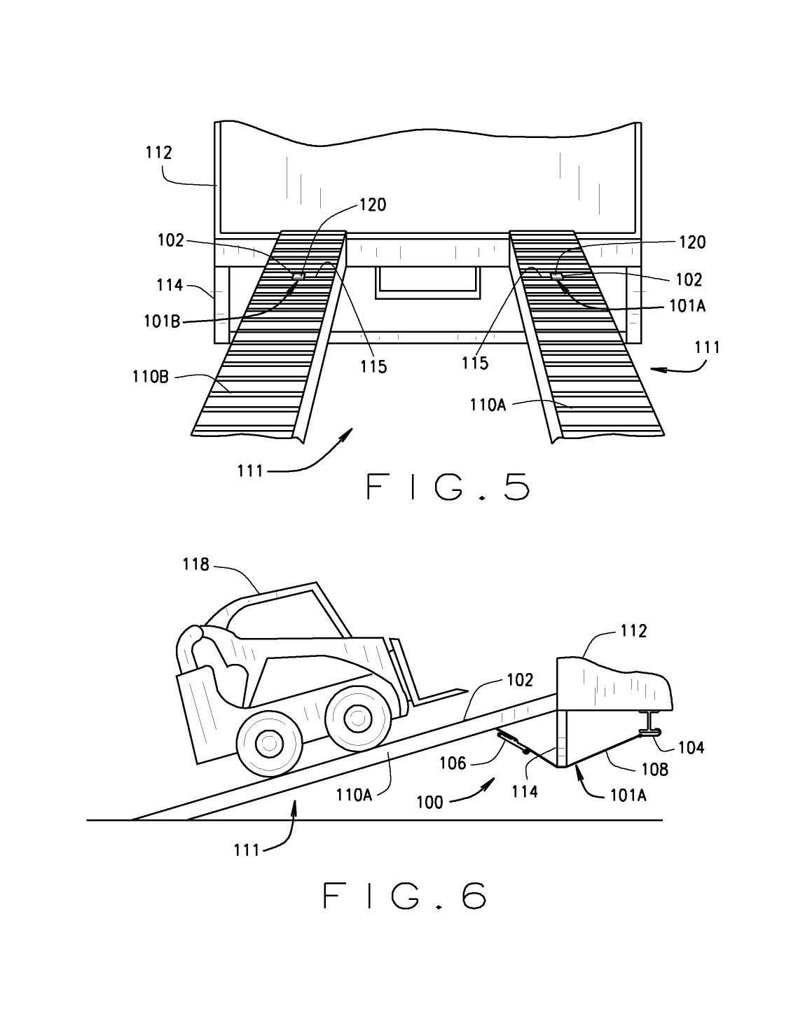

Referring to the drawings, an embodiment of the ramp deployment system is illustrated and generally indicated as 100 in FIGS. 1-7. In general, as shown in FIG. 2, the ramp deployment system 100 is configured to engage a mobile ramp arrangement 111 to a trailer 112 or other type of container vehicle using a ratchet strap mechanism 101 to secure the mobile ramp arrangement 111 to the trailer 112. The ratchet strap mechanism 101 is operatively connected between the mobile ramp arrangement 111 and the trailer 112 to secure and stabilize the mobile ramp arrangement 111 or the trailer 112. As illustrated in FIG. 6, the ramp deployment system 100 may be made from a lightweight metallic material sufficiently strong enough to support the weight of a small utility vehicle 118, such as a forklift, although the type of utility vehicle is not limited in this regard.

Referring to FIGS. 5 and 6 in some embodiments as noted above the ramp deployment system 100 may include a mobile ramp arrangement 111 for supporting the utility vehicle 118 as well as the ratchet strap mechanism 101 for securing the mobile ramp arrangement 111 to the trailer 112. In one aspect, the mobile ramp arrangement 111 may include first and second ramps 110A and 1108 configured for attachment to the opening of the trailer 112. FIG. 5 is a front view the ramp system with the first and second ramps 110A and 1108 connected to the trailer 112 and spaced apart such that the first ramp 110A supports one side of the utility vehicle 118 and the second ramp 1108 supports the opposite side of the utility vehicle 118. In another aspect, the ramp deployment system 100 may include a substantially parallel mobile ramp arrangement 111 for supporting a utility vehicle 118. FIG. 2 shows one arrangement in which the first ramp 110A is connected to the trailer 112 and secured using a first ratchet strap mechanism 101A.

Referring to FIG. 4, the first and second ramps 110A and 110B may each include a respective flange 116 defining a first end 107 configured to abut the floor along the lip of the entrance to the trailer 112 in order to provide an interface between the first and second ramps 110A and 110B and the trailer 112. In some embodiments, the flanges 116 of the first and second ramps 110A and 110B may attach to round rails or rub rails of the trailer 112. The first and second ramps 110A and 110B each include a second end 109 configured to contact a lower surface, such as a road surface or parking lot as illustrated in FIG. 2. In some embodiments, the first and second ramps 110A and 110B may be made of aluminum or any lightweight metallic material capable of supporting a utility vehicle 118. In some embodiments the first and second ramps 110A and 110B each may include cross rungs 115 to provide traction for a utility vehicle 118 and structural integrity to the mobile ramp arrangement 111. In some embodiments, the cross rungs 115 may be serrated to provide additional traction.

In some embodiments, the ratchet strap mechanism 101 may include a first ratchet strap mechanism 101A (FIG. 1A) for securing the first ramp 110A to the trailer 112 and an identical second ratchet strap mechanism 101B (FIG. 1B) for securing the second ramp 110B to the trailer 112. Referring to FIGS. 1A and 1B, each ratchet strap mechanism 101A and 101B defines a first end 102 with a first hook portion 120 and a second end 104 with a second hook portion 122, such that the first end 102 attaches to the ramp 110 and the second end 104 attaches to the trailer 112 as shall be discussed in greater detail below. In some embodiments, each ratchet strap mechanism 101A and 101B further includes a ratchet arrangement 106 that provides a means for tightening and loosening one of a plurality of straps 108. In some embodiments, the plurality of straps 108 may include a tightening strap 140 and a fixed strap 144 that are each coupled to the ratchet arrangement 106. In this arrangement, the fixed strap 144 is maintained in fixed length engagement between the ratchet arrangement 106 and the first hook portion 120 engaged to the ramp 110, while one end of the tightening strap 140 is secured to the ratchet arrangement 106 and the opposite end of the tightening strap 140 is secured to the second hook portion 122 such that actuation of the ratchet arrangement 106 causes the length of the tightening strap 140 to shorten as shall be discussed in greater detail below.

In some embodiments, the ratchet arrangement 106 includes a ratchet handle 152 pivotally engaged to an axle 150 that is coupled to a pair of opposing circular plates 145 and 147 that each define a plurality of teeth that allow the ratchet arrangement 106 to incrementally rotate the axle 150 in a counterclockwise direction D as the handle 152 is pivoted between proximal direction A (FIG. 1A) and distal direction B (FIG. 1B). In addition, as the handle 152 is pivoted in a back-and-forth motion tightening strap 140 is moved in direction C and tightened as the tightening strap 140 is wrapped around the axle 150 as shown in FIG. 1B.

In one arrangement, each ratchet strap mechanism 101A and 101B also includes a spring-loaded portion 142 having an axle 154 coupled to looped end 133 of the fixed strap 144 and an opposite end (not shown) of the spring-loaded portion 154 being engaged to the axle 150 of the ratchet arrangement 106. In addition, the fixed strap 140 may have second looped end 134 coupled to a slot 130 formed at one end of the first hook portion 120, while a first looped end 133 of the tightening strap 144 is coupled to the axle 154 of the spring-loaded portion 142 such that the strap 144 is fixed between the first hook portion 120 and the ratchet arrangement 106.

As further shown, the tightening strap 140 defines a first loop end 136 engaged to a slot 132 defined by the second hook portion 122 and an opposite second loop end 135 wrapped around the axle 150 of the ratchet arrangement 106. In this arrangement the tightening strap 140 becomes wrapped around the axle 150 as the ratchet handle 152 is pivoted in a back-and-forth motion between directions A and B, thereby shortening the overall length of tightening strap 140 and tightening the tightening strap 140 between the second hook portion 122 and the ratchet arrangement 106.

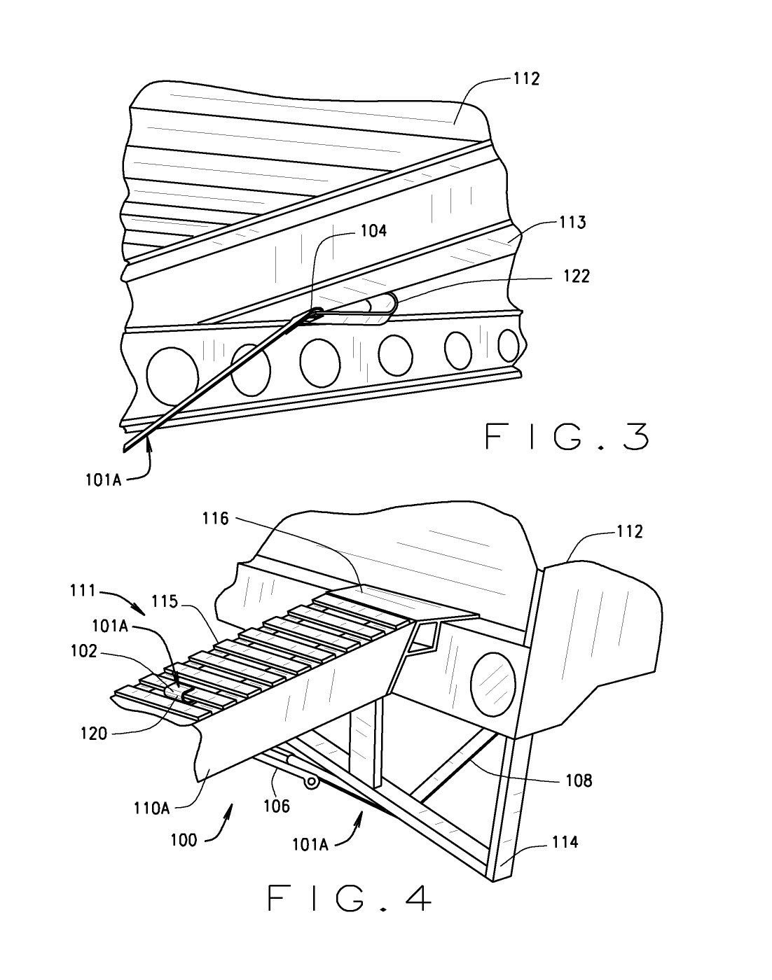

In some embodiments, the first end 102 of each of the first and second ratchet strap mechanisms 101A and 101B is attached to the first and second ramps 110A and 110B on a cross rung 115 located between the first and second ramps 110A and 110B, respectively as shown in FIG. 4. FIGS. 3 and 5 illustrate the engagement of the first ratchet strap 101A between the trailer 112 and the first ramp 110A. In some embodiments, the first hook portion 120 of first end 102 may be engaged to the trailer 112 and the second hook portion 122 of the second end 104 for the first ratchet strap 101A may be engaged to a cross rung 115 of the first ramp 110A. In one embodiment, the second end 104 of each of the first and second ratchet strap mechanisms 101A and 101B may attach to the trailer 112 on a beam 113 or axle on the underside of the trailer 112. Referring specifically to FIG. 3, by way of example, the second end 104 of the first ratchet strap mechanism 101A is connected to a beam 113 on the underside of the trailer 112, which provides additional support for the connection between the trailer 112 and the first ramp 110A. Similarly, the second end 104 of the second ratchet strap mechanism 101B may also be connected to the beam 113 on the underside of the trailer 112. In some embodiments, the first and second ratchet strap mechanisms 101A and 101B may pass below and contact the rear impact guard 114, or ICC bar, of the trailer 112 when the first and second ratchet strap mechanisms 101A and 101B are connected to the trailer 112 as well as the first and second ramps 110A and 110B.

In some embodiments, the strap 108 of the ratchet strap mechanism 101 may be made of industrial grade webbing, including but not limited to nylon webbing. The width of the strap 108 for the ratchet strap mechanism 101 may range from about 1 inch to about 4 inches. The hooks on the first and second ends 102 and 104 of the ratchet strap 101 may be a plastic material, a metal material, or any other suitable material with sufficient strength to attach the strap 108 to an object. Non-limiting example of hooks on the first and second ends 102 and 104 of the ratchet strap mechanism 101 include flat hooks, J-hooks, and S-hooks.

Referring to FIG. 6, the ramp deployment system 100 is configured to support the mobile ramp arrangement 111 in a manner sufficient to bear the weight of a small utility vehicle 118 for transporting a load or bundle into and from the trailer 112. The ramp deployment system 100 is shown in use with a utility vehicle 118 that is supported by both the first and second ramps 110A and 110B secured to the trailer 112 through the first and second ratchet straps 101A and 101B. In an aspect, the mobile ramp arrangement 111 may be deployed such that the first end 107 of the first ramp 110A may engage the entrance of the trailer 112 with a flange 116 to support the right side of a utility vehicle 118, while the first end 107 of the second ramp 110B may similarly engage the entrance to the trailer 112 with a similar flange 116 to support the left side of a utility vehicle 118. When assembled, the ramp deployment system 100 provides a support pathway between the entrance of the trailer 112 and the lower surface for the utility vehicle 118 to ride on. In some embodiments of the mobile ramp arrangement 111, the first and second ramps 110A and 110B are sufficiently spaced apart in parallel orientation to one another to support each respective wheel of the utility vehicle 118.

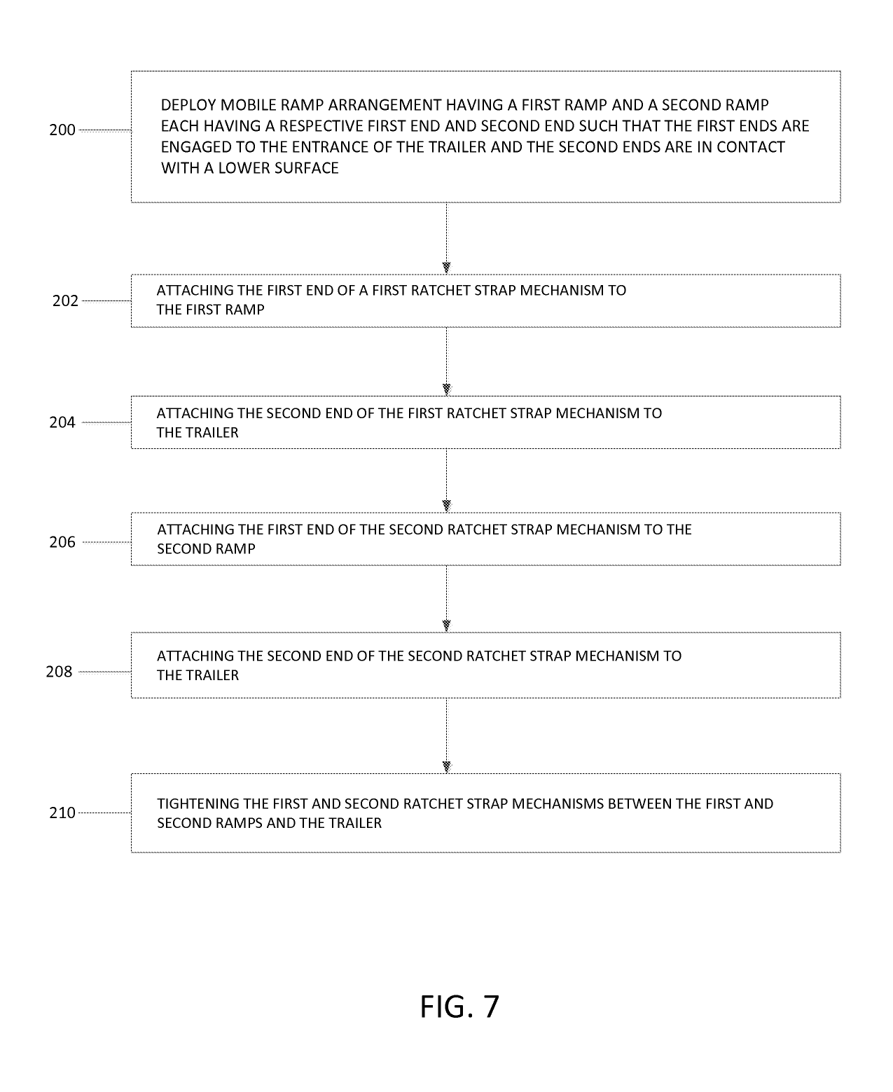

Referring to FIG. 7, a flow chart illustrates one method for deploying the ramp deployment system 100. At step 200, deploy the mobile ramp arrangement 111 such that the respective first ends 107 of the first ramp 110A and second ramp 110B are engaged to the entrance of the trailer 112 and respective second ends 109 of the first ramp and second ramps 110A and 110B are in contact with a lower surface. At block 202, attaching the first end 102 of the first ratchet strap mechanism 101A to the first ramp 110A. At block 204, attaching the second end 104 of the first ratchet strap mechanism 101A to the trailer 112. At block 206, attaching the first end 102 of the second ratchet strap mechanism 101B to the second ramp 110B. At block 208, attaching the second end 104 of the second ratchet strap mechanism 101 B to the trailer 112. At block 210, tightening the first and second ratchet strap mechanisms 101A and 101B between the first and second ramps 110A and 110B and the trailer 112 such that the first and second ramps 110A and 110B are securely engaged to the trailer 112.

As noted above, the ramp deployment system 100 may be used to store and transport bundled items, such as disassembled cardboard boxes, from various sites using the utility vehicle 118 initially stored in the trailer 112 to transport each bundle into the trailer 112. In this particular application of the ramp deployment system 100, the user will deploy the mobile ramp arrangement 111 from the trailer 111 using the ratchet strap mechanisms 101A and 101B to secure the first and second ramps 110A and 110B, respectively between the mobile ramp arrangement 111 and the trailer 112 in order to allow the utility vehicle 118 to transport each bundle into the trailer 111. Once the bundles are transported inside the trailer 112, the utility vehicle 118 is stored in front of the stored bundles and the mobile ramp arrangement 111 may be disengaged from the ratchet strap mechanisms 101A and 101B so that both the first and second ramps 110A and 110B and the ratchet strap mechanisms 101A and 101B may be stored in the trailer 112. Although the ramp deployment system 100 may be used to store and transport bundled items using the utility vehicle 118 as described above, other types of applications for the ramp deployment system 100 are contemplated, such as transportation and storage of a unbundled items that are shrink wrapped onto a pallet or other types of articles that require pick up and transportation.

It should be understood from the foregoing that, while particular embodiments have been illustrated and described, various modifications can be made without departing from the spirit and scope of the invention as will be apparent to those skilled in the art. Such changes and modifications are within the scope and teachings of this invention as defined in the claims appended hereto.

What is claimed is:

1. A ramp deployment system comprising:
a ramp mobile arrangement comprising:
a first ramp and a second ramp, each of the first ramp and second ramp defining a respective first end and a respective second;
a pair of ratchet strap mechanisms, each pair of ratchet strap mechanisms being operatively engaged to the mobile ramp arrangement, each of ratchet strap mechanisms comprising:
a ratchet arrangement having one end coupled to a fixed strap and an opposite end coupled to a tightening strap,
wherein one end of the fixed strap is coupled to a first hook portion configured to engage the first and second ramps, respectively, and an opposite end of the fixed strap is coupled to the ratchet arrangement in a fixed relationship, and
wherein one end of the tightening strap is coupled to a second hook portion configured to engage the trailer and an opposite end of the tightening strap is coupled to the ratchet arrangement such that actuation of the ratchet arrangement incrementally tightens the tightening strap.

2. The ramp deployment system of claim 1, wherein each of the first and second ramps defines a plurality of cross rungs, and wherein the first ends of the first and second ratchet straps are configured to engage a respective cross rung on the first and second ramps, respectively.

3. The ramp deployment system of claim 1, wherein the second ends of the first and second straps connect to a beam on the underside of the trailer.

4. The ramp deployment system of claim 1, wherein the first and second straps contact a rear impact guard of the trailer.

5. The ramp deployment system of claim 1, wherein the second ends of the first and second ramps are configured to contact a lower surface relative to the trailer.

6. The ramp deployment system of claim 1, wherein the flange of the first ramp and the second ramp is configured to engage the trailer.

7. The ramp deployment system of claim 1, wherein the first and second ramps are oriented substantially parallel to one another when connected to the trailer at the respective first ends and the lower surface at the respective second ends.

8. The ramp deployment system of claim 1, wherein the first and second ramps are capable of supporting a small utility vehicle.

9. The ramp deployment system of claim 1, wherein each ratchet mechanism further comprises:
a handle pivotally connected to an axle, the axle being configured to engage the tightening strap such that actuation of the handle in a back-and-forth motion tightens the tightening strap as the tightening strap is wrapped around the axle of the ratchet mechanism.

10. The ramp deployment system of claim 9, wherein the handle is operatively connected to opposing plates engaged to each side of the axle, each of the opposing plates defining a plurality of teeth that permit incremental rotation of the axle as the handle is pivoted in the back-and-forth motion.

11. A method of deploying a ramp deployment system comprising:
deploying a mobile ramp arrangement comprising:
a first ramp and a second ramp, each of the first ramp and second ramp defining a first end defining a flange and a second end configured to contact a lower surface; and
engaging a pair of ratchet strap mechanisms, each of ratchet strap mechanisms being operatively engaged to the mobile ramp arrangement, each of ratchet strap mechanisms comprising:
a ratchet arrangement having one end coupled to a fixed strap and an opposite end coupled to a tightening strap,
wherein one end of the fixed strap is coupled to a first hook portion configured to engage the first and second ramps, respectively, and an opposite end of the fixed strap is coupled to the ratchet arrangement in a fixed relationship, and
wherein one end of the tightening strap is coupled to a second hook portion configured to engage the trailer and an opposite end of the tightening strap is coupled to the ratchet arrangement such that actuation of the ratchet arrangement incrementally tightens the tightening strap.

12. The method of claim 11, wherein engaging the ratchet strap mechanism further comprises:
attaching the first end of the first strap to the first ramp;
attaching the second end of the first strap to the trailer;
attaching the first end of the second strap to the first ramp; and
attaching the second end of the second strap to the trailer.

13. The method of claim 12, further comprising engaging the respective ratchet mechanism to the first ramp and second ramp to successively tighten the first and second straps for securing the first and second ramps to the trailer.

14. The method of claim 12, wherein the first end of the first and second straps attach to a cross rung defined by each of the first and second ramps, respectively.

15. The method of claim 12, wherein the second end of the first and second straps attach to a beam on the underside of the trailer.

16. The method of claim 12, wherein the first and second straps contact a rear impact guard of the trailer.

17. The method of claim 11, wherein deploying the ramp deployment arrangement comprises:
contacting the second end of the first and second ramps to the lower surface; and
engaging the flange of the first ramp and the second ramp to the trailer.

18. The method of claim 15, wherein the first and second ramps are oriented substantially parallel to one another when engaged to the trailer.

19. The method of claim 11, wherein each ratchet mechanism further comprises:
a handle pivotally connected to an axle, the axle being configured to engage the tightening strap such that actuation of the handle in a back-and-forth motion tightens the tightening strap as the tightening strap is wrapped around the axle of the ratchet mechanism.

20. The method of claim 19, wherein the handle is operatively connected to opposing plates engaged to each side of the axle, each of the opposing plates defining a plurality of teeth that permit incremental rotation of the axle as the handle is pivoted in the back-and-forth motion.
